(19) United States
(12) Patent Application Publication
(10) Pub. No.: US 2020/0199899 A1
(43) Pub. Date: Jun. 25, 2020

(54) THERMAL INSULATING STRUCTURE FOR ABOVE-GROUND POOL AND ABOVE-GROUND POOL

(71) Applicant: BESTWAY INFLATABLES & MATERIAL CORP., Shanghai (CN)

(72) Inventors: Shuiyong Huang, Shanghai (CN); Jiangjian DAI, Shanghai (CN); Hongxing ZHANG, Shanghai (CN); Chuan LIU, Shanghai (CN)

(21) Appl. No.: 16/721,884

(22) Filed: Dec. 19, 2019

(30) Foreign Application Priority Data
Dec. 24, 2018 (CN) 201822177917.5

(51) Int. Cl. E04H 4/00

(52) U.S. Cl. CPC E04H 4/0025; B32B 1/00; B32B 2307/416; B32B 2307/304

(57) ABSTRACT

A thermal insulating structure for an above-ground pool and an above-ground pool are provided. The thermal insulating structure includes a thermal insulating layer and an enveloping layer. The thermal insulating layer includes a flexible layer, a fabric layer, and a reflective layer bonded to the flexible layer. The enveloping layer is connected to an inside or an outside of the pool to form a chamber for accommodating the thermal insulating layer. The thermal insulating layer can be located on a side of the above-ground pool and at a bottom of the above-ground pool. The thermal insulating structure can be formed into an integrated structure with the above-ground pool at a low cost and a relatively simple manufacturing process, and is suitable for large-scale industrial production and application.

### CROSS-REFERENCE TO RELATED APPLICATION

This U.S. patent application claims priority to and the benefit of Chinese patent application number 201822177917.5, filed Dec. 24, 2018, the entire disclosure of which is hereby incorporated by reference.

### BACKGROUND OF THE INVENTION

### 1. Field of the Invention

The present disclosure generally relates to an above-ground pool. More particularly, the present disclosure generally relates to a thermal insulating structure for an above-ground pool and an above-ground pool having a thermal insulating structure.

### 2. Related Art

This section provides background information related to the present disclosure which is not necessarily prior art

Above-ground pools are recreational products used in outdoor open spaces. For example, an above-ground pool may be installed with relative ease in a backyard, front yard, or any other open space. Playing and exercising in pools are popular pastimes of both young and old. Above-ground pools are a particularly popular type of pool due to their ease of installation, long-term life, and safety benefits over in-ground pools that are known to create risks to young children. Currently, there are mainly two types of above-ground pools: frame pools and inflatable pools, both of which have various structures and configurations. During use, the temperature of the water in the pool is preferably maintained in a temperature range close to that of the human body. In addition, with user demands increasing and expanding geographically, more and more users expect to experience enjoyment of above-ground pools in colder temperatures. This makes it increasingly important to heat and maintain the water in the above-ground pool at a comfortable temperature.

While there are known inflatable pools with a heating feature (such as SPA pools), they typically have no thermal insulation. Since the pool bodies are mostly made of PVC (polyvinyl chloride) material, the thermal insulation is limited to inflated air chambers, which are typically poor insulators. When the pool is not used and the ambient temperature is low, the temperature of the water in the pool will continuously decrease and a heater needs to repeatedly start an energy-intensive heating program to keep the water warm, resulting in wasted energy. While there have been some attempts to improve insulation, these attempts have been lacking and are typically limited to adding a thermal insulating cover or lid to the outside of the pool body. For example, as shown in FIG. 1, a lid 3 is added to the top of a pool 1, and a thermal insulating mat 2 is added to the outside of the pool 1. Thermal insulating mats 2 generally extend from the bottom to the side of the pool body and cover the entire side of the pool body. While an improvement, these prior art methods still provide poor insulation, thus leading to a short heat preservation time and fast heat dissipation. Moreover, conventional thermal insulating materials on the market cannot be connected to PVC material and an independent structure for fixing the thermal insulating material to the pool needs to be provided, thus resulting in a complicated, sometimes weakened structure and inconvenient use.

### SUMMARY OF THE INVENTION

The following outlines certain features of embodiments of the present invention such that the detailed description of the invention that follows may be better understood. Additional features of embodiments of the present invention will be described hereinafter. It should be appreciated by those skilled in the art that the general concepts and the specific embodiments disclosed herein may be readily utilized as bases for modifying or designing other embodiments for carrying out the same or similar purposes of the present invention. It should also be realized by those skilled in the art that such equivalent embodiments do not depart from the spirit and scope of the invention, as set forth in the appended claims.

Objects of the present disclosure include solving at least the above problems in the prior art and providing a thermal insulating structure that can be used in an above-ground pool. The thermal insulating structure can achieve long-term, effective thermal insulation and be incorporated on the pool body.

As such, according to one aspect of the present disclosure, a thermal insulating structure for an above-ground pool provided. The thermal insulating structure comprises a thermal insulating layer that includes a flexible layer and an enveloping layer that configured to be connected to the above-ground pool to form a chamber between the enveloping layer and the above-ground pool for placing the thermal insulating layer in the chamber and holding the thermal insulating layer alongside the above-ground pool.

According to another aspect of the present disclosure, the thermal insulating layer further comprises a reflective layer and a fabric layer, wherein the fabric layer is sandwiched between and bonded to both the reflective layer and the flexible layer.

According to another aspect of the present disclosure, the thermal insulating layer further includes at least one connecting strip connected to the enveloping layer for limiting movement of the thermal insulating layer in the chamber.

According to yet another aspect of the present disclosure, the thermal insulating layer further comprises an inner layer sheet connected to the enveloping layer, wherein the enveloping layer and the inner layer sheet surround the thermal insulating layer for limiting movement of the thermal insulating layer in the chamber.

According to another aspect of the present disclosure, the thermal insulating structure further comprises an inner layer sheet provided in the chamber, and the inner layer sheet is connected to the enveloping layer and envelops the thermal insulating layer.

In yet another aspect of the disclosure, the flexible layer comprises pearl cotton or sponge, the fabric layer comprises woven fabric, and the reflective layer comprises aluminum film.

According to another aspect, the enveloping layer comprises at least one of flexible PVC, PU, PVC netted sandwich fabric, and PU netted sandwich fabric.

According to another aspect, an above-ground pool is presented. The above-ground pool comprises a pool body that includes a wall having an inner wall and an outer wall. The above-ground pool further includes a thermal insulating structure, wherein the thermal insulating structure comprises a thermal insulating layer; and an enveloping layer connected to one of the inner wall and the outer wall to form a chamber between the enveloping layer and one of the inner wall and the outer wall. The chamber is arranged for placing the thermal insulating layer in the chamber and holding the thermal insulating layer alongside one of the inner wall and the outer wall.

According to another aspect, the above-ground pool comprises an inflatable pool. The inflatable pool comprises an upper enclosing sheet connecting a top of the inner wall to a top of the outer wall, a lower enclosing sheet connecting a bottom of the inner wall to a bottom of the outer wall, and a closed air cavity between the inner wall, the outer wall, the upper enclosing sheet and the lower enclosing sheet. The enveloping layer is connected adjacent to the bottom of the inner wall and extends upwardly and is connected adjacent to the top of the inner wall for placing the thermal insulating layer alongside the inner wall.

According to another aspect, the above-ground pool comprises an inflatable pool. The inflatable pool comprises an upper enclosing sheet connecting a top of the inner wall to a top of the outer wall, a lower enclosing sheet connecting a bottom of the inner wall to a bottom of the outer wall, and a closed air cavity between the inner wall, the outer wall, the upper enclosing sheet and the lower enclosing sheet. The enveloping layer is connected adjacent to the bottom of the outer wall and extends upwardly and is connected adjacent to the top of the outer wall for placing the thermal insulating layer alongside the outer wall.

According to another aspect, the above-ground pool comprises an inflatable pool. The inflatable pool comprises an upper enclosing sheet connecting a top of the inner wall to a top of the outer wall, a lower enclosing sheet connecting a bottom of the inner wall to a bottom of the outer wall, and a closed air cavity between the inner wall, the outer wall, the upper enclosing sheet and the lower enclosing sheet. The enveloping layer is connected to the lower enclosing sheet, extends upwardly, and is connected to the upper enclosing sheet for placing the thermal insulating layer alongside one of the inner wall and the outer wall.

According to another aspect of the present disclosure, an above-ground pool is provided. The above-ground pool comprises a pool body, including a wall having an inner wall and an outer wall and a pool bottom sealingly connected to the inner wall and the outer wall. The above-ground pool further includes a thermal insulating structure comprising one of a thermal insulating bladder covering the inner wall and an inner side of the pool bottom or a thermal insulating jacket covering the outer wall and an outer side of the pool bottom.

According to another aspect of the present disclosure, the above-ground pool further includes a thermal insulating lid having an inflatable bladder.

According to another aspect of the present disclosure, the thermal insulating lid includes an outside surface, an inside surface and a heat insulating layer. The outside surface includes an outer enveloping layer detachably connected to the outer wall of the pool body, and the heat insulating layer is sandwiched between the inflatable bladder and the outer enveloping layer.

According to another aspect of the present disclosure, the inflatable bladder is connected to the heat insulating layer by a woven fabric.

According to another aspect of the present disclosure, an above-ground pool is provided. The above-ground pool comprises a wall extending between a top and a bottom thereof and a pool bottom connected to and forming a seal along the bottom of the wall. A first thermal insulating structure is connected to the wall and a second thermal insulating structure is connected to the pool bottom. A gap exists between the first thermal insulating structure and the second insulating structure such that water resides within the gap when the above-ground pool is filled with water.

### BRIEF DESCRIPTION OF THE DRAWINGS

The drawings described herein are only for illustrative purposes of selected embodiments and are not intended to limit the scope of the present disclosure. The inventive concepts associated with the present disclosure will be more readily understood by reference to the following description in combination with the accompanying drawings wherein:

FIG. 1 is a schematic sectional view of prior art inflatable pool having a pool body, wherein a lid covers an upper side of the pool body;

FIG. 2 is a perspective view of an inflatable pool having a pool body, according to an embodiment of the present disclosure, wherein a thermal insulating structure is provided on an inside of the pool body;

FIG. 3 is an exploded perspective view of the inflatable pool shown in FIG. 2;

FIG. 4 is a perspective view of an inflatable pool, according to another embodiment of the present disclosure, wherein the thermal insulating structure is provided at an outside of the pool body;

FIG. 5 is an exploded perspective view of the pool shown in FIG. 4;

FIG. 6 is a partially-exploded perspective view of a thermal insulating layer, according to another aspect of the present disclosure;

FIG. 7 is a cross-sectional view of the thermal insulating layer shown in FIG. 6;

FIG. 8 is a schematic view showing a thermal insulating structure provided at the inside of the pool, with an enveloping layer connected to an extension of an upper enclosing sheet of an air chamber;

FIG. 9 is similar to FIG. 8, with the enveloping layer connected to a higher portion of the upper enclosing sheet of the air chamber;

FIG. 10 is similar to FIG. 8, with the enveloping layer connected to an outer wall of the air chamber;

FIG. 11 is similar to FIG. 9, with the thermal insulating structure provided with an inner layer sheet;

FIG. 12 is a schematic view showing the thermal insulating structure provided at the outside of the pool, with the enveloping layer connected to a top end of the outer wall of the air chamber;

FIG. 13 is similar to FIG. 12, with the enveloping layer connected to the upper and lower enclosing sheets of the air chamber and to the enveloping layer of the thermal insulating structure that is connected to the outer side of the pool bottom;

FIG. 14 is a sectional view showing the outside of a pool provided with a thermal insulating jacket and the pool covered with a thermal lid, in accordance with another aspect of the disclosure; and

FIG. 15 is a sectional view showing the inside of the pool provided with a thermal insulating bladder and the pool covered with a thermal insulating lid, in accordance with yet another aspect of the disclosure.

### DESCRIPTION OF THE ENABLING EMBODIMENTS

Exemplary embodiments will now be described more fully with reference to the accompanying drawings. In general, the subject embodiments are directed to a thermal insulating structure for an above-ground pool and an above-ground pool having the thermal insulating structure. However, the exemplary embodiments are only illustrative of the various features of the present invention, as those skilled in the art understanding that various changes thereto may be made without departing from the full scope of the invention. Numerous specific details are set forth, such as examples of specific components, devices, and methods, to provide a thorough understanding of the embodiments of the present disclosure. It will be apparent to those skilled in the art that specific details need not be employed, that exemplary embodiments may be altered in many different forms and that neither should be construed to limit the scope of the disclosure. In some exemplary embodiments, well-known processes, well-known device structures, and well-known technologies are not described in detail.

The implementation and usage of the embodiments will be discussed in detail below. However, it should be understood that the specific embodiments discussed herein are merely illustrative of specific ways to implement and use the present disclosure and do not delimit the scope of the present disclosure. In the description for the structural positions of various components, representations of directions, such as “upper,” “lower,” “top” and “bottom,” are not absolute, but relative. When the various components are arranged, as shown in the drawings, these representations of directions are appropriate. However, when the positions of the various components in the drawings are changed, these representations of directions are changed accordingly.

In addition, “inner” refers to a direction toward the water storage area of the pool, and “outer” refers to a direction toward the outside of the whole pool.

According to the present disclosure, a thermal insulating structure, which can be integrated with an above-ground pool 5, is provided. Here, the above-ground pool 5 is a pool suitable for being used on the ground, such as a frame pool or an inflatable pool. Hereinafter, especially, the inflatable pool 5 is taken as an example for purposes of description. The so-called “integrated with” means that the thermal insulating structure can be fixedly connected to the pool and will not be detached during use.

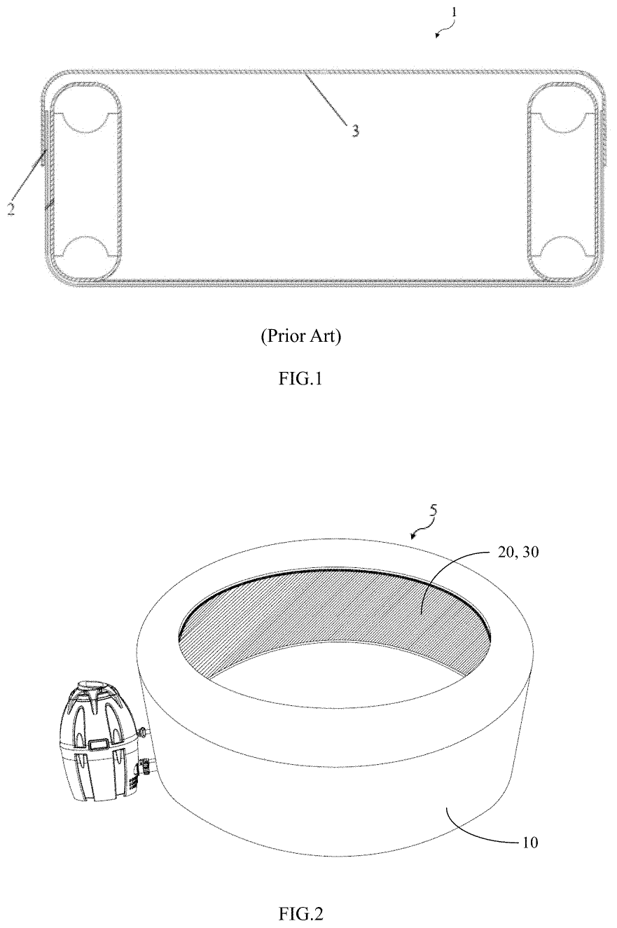

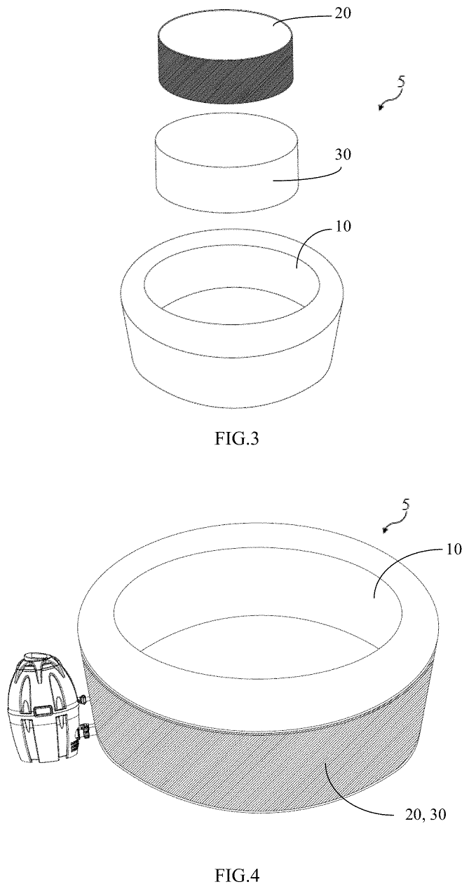

With initial reference to FIGS. 2 through 5, the pool 5 includes a pool body 10 that is advantageously provided with the thermal insulating structure 20 at the inside or outside thereof. As shown in FIG. 2, when provided at the inside of the pool 5, the thermal insulating structure 20 may include a first thermal insulating layer 31 that is bonded to an inner wall 11 of the pool body 10 or the outer wall 15 of the pool body 10 by a first enveloping layer 30. The first enveloping layer 30 may be configured for being connected to the inside or outside of the pool 5 to form a first chamber 6 for accommodating the first thermal insulating layer 31. In this manner, the first enveloping layer 30 can provide additional thermal insulation and also protect and hold the first thermal insulating layer 31 in place. The first enveloping layer 30 may further provide an enhanced and streamlined appearance while it covers the first thermal insulating layer 31. Optionally, the first enveloping layer 30 may be made of at least one of flexible PVC, PU, PVC netted sandwich fabric, and PU netted sandwich fabric. The above materials are similar to the materials of which the pool 5 is made and can be easily joined to the pool by, for example, sewing, welding, hot-melt connecting, or other methods of adhering.

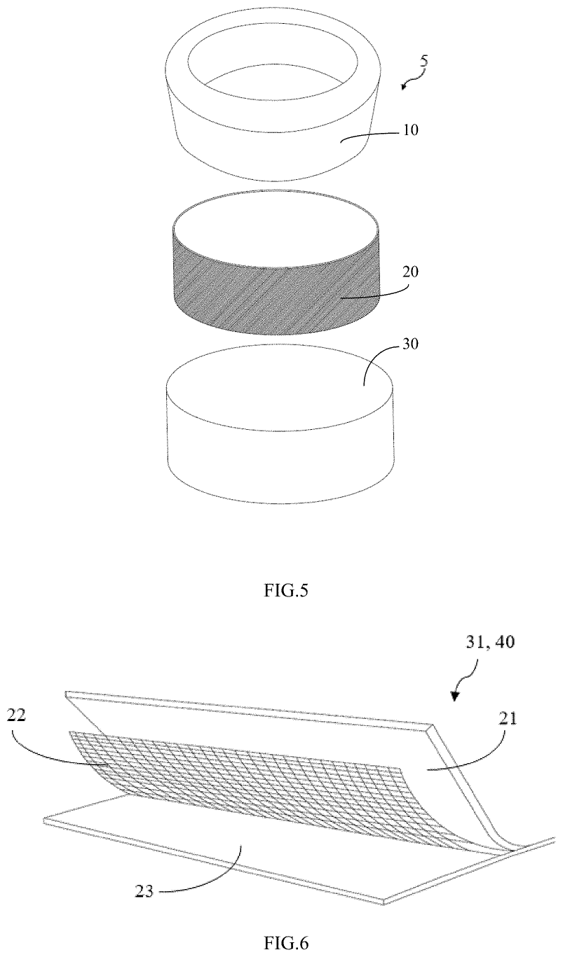

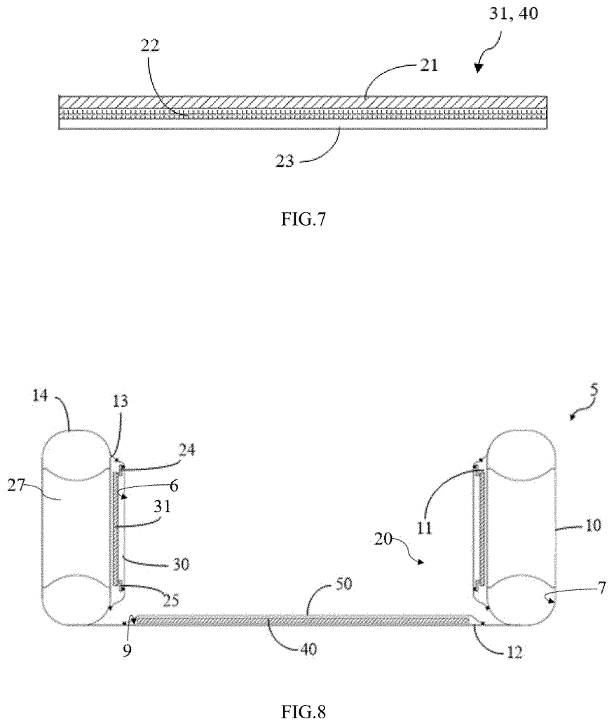

FIGS. 6 and 7 illustrate one embodiment of the thermal insulating layer 31, 40. The thermal insulating layer 31, 40 may include a three-layer structure, including a flexible layer 21, a fabric layer 22 and a reflective layer 23 that are successively connected. In other words, the fabric layer 22 is sandwiched between the flexible layer 21 and the reflective layer 23. In some embodiments, the flexible layer 21 may be pearl cotton or sponge for thermal insulation. The fabric layer 22 may be a woven fabric that is bonded to the reflective layer 23, which may be an aluminum film, such as foil, to reflect heat inwardly and to prevent heat transfer. It should be understood that the thermal insulating layer 31, 40 may be selected to include any one, two, or three of the layers in various orders. The above three-layer structure may alternatively only include the flexible layer 21 for thermal insulation.

Various alternative examples of different ways in which the thermal insulating structure 20 may be connected to the inflatable pool 5 will be described in detail below and with reference to FIGS. 8 through 15. In various embodiments, pool 5 is an inflatable pool and the pool body 10 has an air cavity 7. The air cavity 7 is surrounded by the inner wall 11, the outer wall 15, an upper enclosing sheet 14, and a lower enclosing sheet 16 that, together, form a closed structure around the air cavity 7.

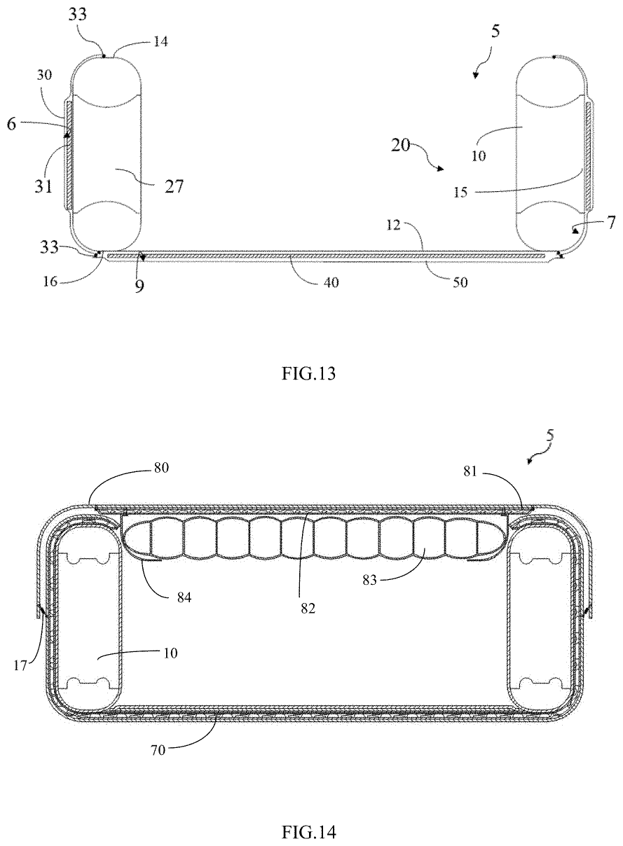

Referring to FIG. 8, the first thermal insulating layer 31 of the thermal insulating structure 20 is provided at the inside of the pool 5 at the inner wall 11 of the pool body 10. As can be seen in FIG. 8, the first enveloping layer 30 is connected to the bottom end of the inner wall 11, extends upwardly, and is connected to an extension 13 of the upper enclosing sheet 14, thus forming the first chamber 6 for accommodating the first thermal insulating layer 31. In this embodiment, the first thermal insulating layer 31 may include at least one connecting strip, such as an upper connecting strip 24 and a lower connecting strip 25, for being respectively connected to the first enveloping layer 30. The connecting strips 24, 25 improve the connection between the first thermal insulating layer 31 and the first enveloping layer 30 and/or the pool body 10. Both the first enveloping layer 30 and the pool body 10 may be made of, for example, a PVC material and connection can be made therewith by a simple welding, a hot-melt connection, or the like. The flexible layer 21 may be made of, for example, pearl cotton, which is not easily connected to common materials of the pool body 10. As such, in accordance with one aspect of the disclosure, the first thermal insulating layer 31 can be easily fixed to the first enveloping layer 30 by means of one or both of the connecting strips 24, 25 by, for example, welding. After the connecting strips 24, 25 are attached to the first enveloping layer 30, the first enveloping layer 30 may then be welded to the pool body 10. Because the connecting strips 24, 25 may be made of a material similar to that of the first enveloping layer 30, they can be connected to the first enveloping layer 30 by heat bonding or sewing. The various connection positions are shown in the form of black dots 33 (see, for example, FIGS. 12 and 13).

As illustrated in FIGS. 8 through 13, the thermal insulating structure 20 may include a second (i.e., bottom) thermal insulating layer 40 that is connected to the pool bottom 12. The bottom insulating layer 40 may be bonded to the pool bottom 12 by a second (i.e., bottom) enveloping layer 50. The bottom enveloping layer 50 may be connected to an inner side of the pool bottom 12 and envelop the bottom thermal insulating layer 40 therewith. The connection of the bottom enveloping layer 50 may be accomplished with the same techniques as those previously described in reference to the first enveloping layer 30, for example, by high frequency welding. The connection positions of the second enveloping layer 50 are also illustrated as black dots 33 throughout the Figures.

The embodiment shown in FIG. 9 is similar to that in FIG. 8 except that the first enveloping layer 30 is connected to the bottom end of the inner wall 11 and extends upwardly to and is connected with the upper enclosing sheet 14. In some embodiments, the first enveloping layer 30 may extend to the center of the upper enclosing sheet 14.

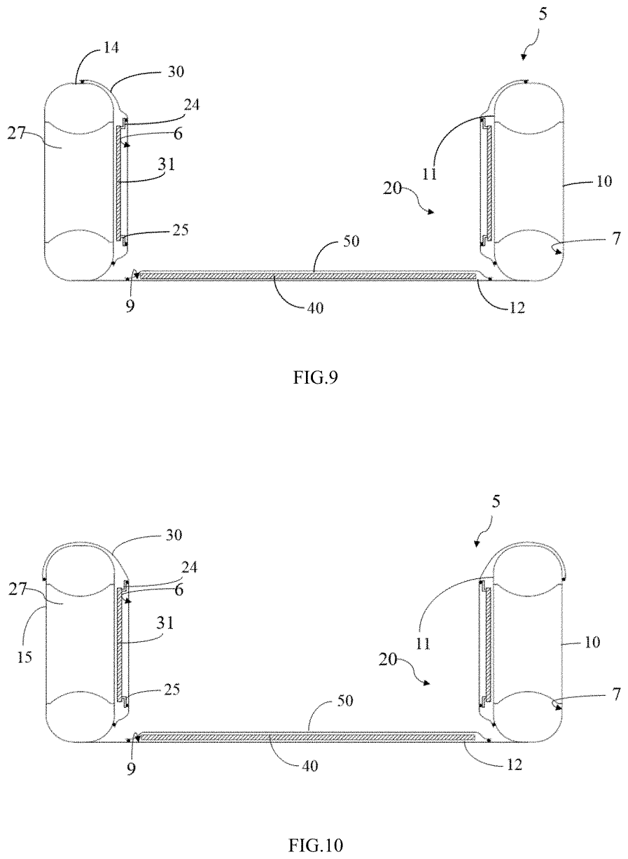

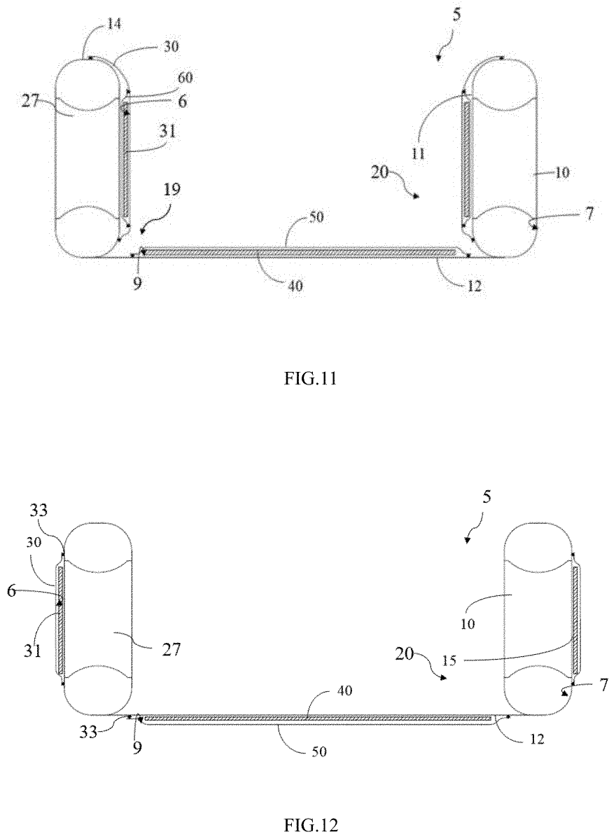

The embodiment shown in FIG. 10 is similar to that in FIG. 8 except that the first enveloping layer 30 is connected to the bottom end of the inner wall 11 and extends upwardly to and is connected with a top end of the outer wall 15. In some embodiments, the location at which the first enveloping layer 30 is connected to the top end of the outer wall 15 may be higher than the position of an upper end of a drawstring 27 in the air cavity 7.

The embodiment shown in FIG. 11 is similar to that in FIG. 9 except that the first thermal insulating layer 31 is not provided with connecting strips 24, 25. Instead, an inner layer sheet 60 is provided in the first chamber 6 formed by the first enveloping layer 30. The inner layer sheet 60 may be selected to be made of a material similar to that of the first enveloping layer 30. Thus, the inner layer sheet 60 can be connected to the first enveloping layer 30 by, for example, welding or the other previously described techniques. Similarly, the first thermal insulating layer 31 can be enveloped in a narrower compartment formed between the inner layer sheet 60 and the enveloping layer 30, such that the first thermal insulating layer 31 is sandwiched and fixed. As shown, water may reside within a gap 19 between the thermal insulation layers 31, 40 when the above-ground pool is filled with water.

FIG. 12 shows an embodiment in which the first thermal insulating structure 20 is provided at the outside of the pool 5. More particularly, the first thermal insulation layer 31 is connected to the outer wall 15 and the bottom thermal insulating layer 40 is connected to the outer side of the pool bottom 12. More particularly, the first enveloping layer 30 is connected to the bottom end of the outer wall 15 and extends upwardly to and is connected with the top end of the outer wall 15, thus forming the first air chamber 6 for accommodating the first thermal insulation layer 31. Similarly, the bottom enveloping layer 50 is connected to the outer side of the pool bottom 12 and envelops the bottom thermal insulating layer 40 in a second (i.e., bottom) chamber 9. It should be appreciated that the connecting strips 24, 25 may also be provided for the thermal insulating layers 31, 40, or an inner layer sheet 60 may be provided in the chambers 6, 9.

The embodiment shown in FIG. 13 is similar to that in FIG. 12 except that the first enveloping layer 30 is connected to the upper enclosing sheet 14 and extends to and is connected with the lower enclosing sheet 16. The bottom enveloping layer 50 is connected to the outer side of the pool bottom 12.

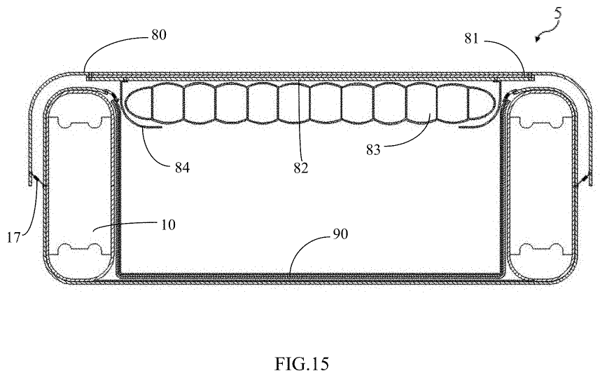

In the embodiment shown in FIG. 14, the thermal insulating structure 20 may include a thermal insulating jacket 70. The thermal insulating jacket 70 is provided at the outer wall 15 of the pool body 10 and the outer side of the pool bottom 12. As illustrated, the thermal insulating jacket 70 may be integrally formed to completely cover the outer wall 15 of the pool body 10 and the outer side of the pool bottom 12 to provide thermal insulation. As shown in FIG. 15, the thermal insulating structure 20 may alternatively include a thermal insulating bladder 90 to completely cover the inner wall 11 of the pool body 10 and the inner side of the pool bottom 12.

FIGS. 14 and 15 also show a thermal insulating lid 80 that may be placed on the top of the pool 5. The thermal insulating lid 80 may be detachably connected to a connecting member 17 provided on the outer wall 15 of the pool body 10. In the illustrated embodiments, the thermal insulating lid 80 includes, from the outside to the inside, a third (i.e., outer) enveloping layer 81, a heat insulating layer 82 connected to the outer enveloping layer 81, and an inflatable bladder 83 connected to the heat insulating layer 82. As an example, the outer enveloping layer 81 may be made of at least one of flexible PVC, PU, PVC netted sandwich fabric, and PU netted sandwich fabric. The heat insulating layer 82 may be made by bonding pearl cotton to an aluminum film. The inflatable bladder 83 may be bonded to a woven fabric 84 and the woven fabric 84 may be bonded to the heat insulating layer 82, such that heat within the pool 5 can be preserved.

In an alternative embodiment, an inflatable thermal insulating bladder 83 may also be provided within the inside of the pool body 10 and may form a dual air-chamber structure with air chambers to more effectively prevent heat from being dissipated.

It should be understood that the embodiments shown in FIGS. 2 through 15 only show the alternative shapes, sizes and arrangements of various embodiments of the thermal insulating structure 20 and reference its application particularly in an inflatable pool. However, these embodiments are merely illustrative and not restrictive. Other shapes, sizes, and arrangements can be employed without departing from the spirit and scope of the present disclosure. Various components and features described herein may be made from a variety of materials, including but not limited to polymers exemplified above, as well as other suitable materials well known to those skilled in the art (such as rubber, foam, metal and coated fabric) or a combination thereof.

The technical content and technical features of the present disclosure have been disclosed above. However, it should be understood that those skilled in the art can make various variations and improvements to the above disclosed concepts under the inventive idea of the present disclosure, and all these variations and improvements belong to the scope of protection of the present disclosure. The description for the above embodiments is illustrative and not restrictive, and the scope of protection of the present disclosure is determined by the claims. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of disclosure.

What is claimed is:

1. A thermal insulating structure for an above-ground pool, wherein the thermal insulating structure comprises:
a thermal insulating layer including a flexible layer; and
an enveloping layer configured to be connected to the above-ground pool to form a chamber between the enveloping layer and the above-ground pool for placing the thermal insulating layer in the chamber and holding the thermal insulating layer alongside the above-ground pool.

2. The thermal insulating structure according to claim 1, wherein the thermal insulating layer further comprises a reflective layer and a fabric layer, wherein the fabric layer is sandwiched between and bonded to both the reflective layer and the flexible layer.

3. The thermal insulating structure according to claim 1, wherein the thermal insulating layer further includes at least one connecting strip connected to the enveloping layer for limiting movement of the thermal insulating layer in the chamber.

4. The thermal insulating structure according to claim 1, further comprising an inner layer sheet connected to the enveloping layer, wherein the enveloping layer and the inner layer sheet surround the thermal insulating layer for limiting movement of the thermal insulating layer in the chamber.

5. The thermal insulating structure according to claim 1, wherein the flexible layer comprises pearl cotton or sponge.

6. The thermal insulating structure according to claim 2, wherein the fabric layer comprises woven fabric.

7. The thermal insulating structure according to claim 2, wherein the reflective layer comprises aluminum film.

8. The thermal insulating structure according to claim 1, wherein the enveloping layer comprises at least one of flexible PVC, PU, PVC netted sandwich fabric, and PU netted sandwich fabric.

9. An above-ground pool, comprising:
a pool body, including a wall having an inner wall and an outer wall;
wherein the above-ground pool includes a thermal insulating structure, the thermal insulating structure comprising:
a thermal insulating layer; and
an enveloping layer connected to one of the inner wall and the outer wall to form a chamber between the enveloping layer and one of the inner wall and the outer wall for placing the thermal insulating layer in the chamber and holding the thermal insulating layer alongside one of the inner wall and the outer wall.

10. The above-ground pool according to claim 9, wherein the thermal insulating layer further comprises a flexible layer, a reflective layer and a fabric layer, wherein the fabric layer is sandwiched between and bonded to both the reflective layer and the flexible layer.

11. The above-ground pool according to claim 9, wherein the thermal insulating layer further includes at least one connecting strip connected to the enveloping layer for limiting movement of the thermal insulating layer in the chamber.

12. The above-ground pool according to claim 9, wherein the thermal insulating structure further comprises an inner layer sheet connected to the enveloping layer, wherein the enveloping layer and the inner layer sheet surround the thermal insulating layer for limiting movement of the thermal insulating layer in the chamber.

13. The above-ground pool according to claim 10, wherein the flexible layer comprises pearl cotton or sponge.

14. The above-ground pool according to claim 10, wherein the fabric layer comprises woven fabric.

15. The above-ground pool according to claim 10, wherein the reflective layer comprises aluminum film.

16. The above-ground pool according to claim 9, wherein the enveloping layer comprises at least one of flexible PVC, PU, PVC netted sandwich fabric, and PU netted sandwich fabric.

17. The above-ground pool according to claim 9, wherein the above-ground pool comprises an inflatable pool, comprising:
an upper enclosing sheet connecting a top of the inner wall to a top of the outer wall;
a lower enclosing sheet connecting a bottom of the inner wall to a bottom of the outer wall; and
a closed air cavity between the inner wall, the outer wall, the upper enclosing sheet and the lower enclosing sheet;
wherein the enveloping layer is connected adjacent to the bottom of the inner wall and extends upwardly and is connected adjacent to the top of the inner wall for placing the thermal insulating layer alongside the inner wall.

18. The above-ground pool according to claim 9, wherein the above-ground pool comprises an inflatable pool, comprising:
an upper enclosing sheet connecting a top of the inner wall to a top of the outer wall;
a lower enclosing sheet connecting a bottom of the inner wall to a bottom of the outer wall; and
a closed air cavity between the inner wall, the outer wall, the upper enclosing sheet and the lower enclosing sheet;
wherein the enveloping layer is connected adjacent to the bottom of the outer wall and extends upwardly and is connected adjacent to the top of the outer wall for placing the thermal insulating layer alongside the outer wall.

19. The above-ground pool according to claim 9, wherein the above-ground pool comprises an inflatable pool, comprising:
an upper enclosing sheet connecting a top of the inner wall to a top of the outer wall;
a lower enclosing sheet connecting a bottom of the inner wall to a bottom of the outer wall; and
a closed air cavity between the inner wall, the outer wall, the upper enclosing sheet and the lower enclosing sheet;
wherein the enveloping layer is connected to the lower enclosing sheet and extends upwardly and is connected to the upper enclosing sheet for placing the thermal insulating layer alongside one of the inner wall and the outer wall.

20. An above-ground pool, comprising:
a pool body, including a wall having an inner wall and an outer wall;
a pool bottom sealingly connected to the inner wall and the outer wall; and
a thermal insulating structure comprising one of:
a thermal insulating bladder covering the inner wall and an inner side of the pool bottom; and
a thermal insulating jacket covering the outer wall and an outer side of the pool bottom.

21. The above-ground pool according to claim 20, wherein the above-ground pool further includes a thermal insulating lid having an inflatable bladder.

22. The above-ground pool according to claim 21, wherein the thermal insulating lid includes an outside surface, an inside surface and a heat insulating layer, wherein the outside surface includes an outer enveloping layer detachably connected to the outer wall of the pool body, and wherein the heat insulating layer is sandwiched between the inflatable bladder and the outer enveloping layer.

23. The above-ground pool according to claim 22, wherein the heat insulating layer is made by bonding pearl cotton to aluminum film.

24. The above-ground pool according to claim 22, wherein the outer enveloping layer is made of at least one of flexible PVC, PU, PVC netted sandwich fabric, and PU netted sandwich fabric.

25. The above-ground pool according to claim 22, wherein the inflatable bladder is connected to the heat insulating layer by a woven fabric.

26. An above-ground pool, comprising:
a wall extending between a top and a bottom thereof;
a pool bottom connected to and forming a seal along the bottom of the wall;
a first thermal insulating structure connected to the wall; and
a second thermal insulating structure connected to the pool bottom, wherein a gap exists between the first thermal insulating structure and the second insulating structure such that water resides within the gap when the above-ground pool is filled with water.
